(19) United States
(12) Patent Application Publication
(10) Pub. No.: US 2026/0311537 A1
(43) Pub. Date: Oct. 8, 2026

(54) BANKNOTE HANDLING DEVICE AND CONVERSION TABLE CREATION METHOD

(71) Applicants: FUJITSU FRONTECH LIMITED, Tokyo (JP); Fujitsu Frontech Systems Limited, Maebashi-shi (JP)

(72) Inventor: Takanori SAGAMI, Inagi (JP)

(73) Assignees: FUJITSU FRONTECH LIMITED, Tokyo (JP); Fujitsu Frontech Systems Limited, Maebashi-shi (JP)

(21) Appl. No.: 19/684,107

(22) Filed: May 21, 2026

Related U.S. Application Data
(63) Continuation of application No. PCT/JP2023/042242, filed on Nov. 24, 2023.

(51) Int. Cl. G07D 7/164

(52) U.S. Cl. CPC G07D 7/164

(57) ABSTRACT

A banknote handling device includes a thickness sensor module that includes a thickness sensor configured to detect a thickness of a banknote, and a memory and a control board that includes a processor, wherein the processor reads a plurality of pieces of reference data from the memory, the pieces of reference data indicating association between a detection value of the thickness sensor and a measurement value of the thickness of the banknote, and being stored in the memory, creates a conversion table for converting the detection value into the measurement value, based on the pieces of reference data, and writes the conversion table into the memory.

### CROSS-REFERENCE TO RELATED APPLICATION

This application is a continuation application of International Application PCT/JP2023/042242, filed on Nov. 24, 2023, and designating the U.S., the entire contents of which are incorporated herein by reference.

### FIELD

The present invention relates to a banknote handling device and a conversion table creation method.

### BACKGROUND

A banknote handling device used for automatic teller machines (ATMs) and the like includes a banknote discriminating unit for discriminating banknotes. For example, the banknote discriminating unit includes a conveyance mechanism for conveying banknotes, and a plurality of types of sensor modules used for discriminating banknotes conveyed by the conveyance mechanism. For example, one of the sensor modules used for discriminating banknotes includes a thickness sensor module for measuring the thickness of banknotes.
Patent Document 1: Japanese Laid-open Patent Publication No. 2023-057402
Patent Document 2: Japanese Laid-open Patent Publication No. 2022-042446

### SUMMARY

According to an aspect of the embodiments, a banknote handling device includes: a thickness sensor module that includes a thickness sensor configured to detect a thickness of a banknote, and a memory; and a control board that includes a processor, wherein the processor reads a plurality of pieces of reference data from the memory, the pieces of reference data indicating association between a detection value of the thickness sensor and a measurement value of the thickness of the banknote, and being stored in the memory, creates a conversion table for converting the detection value into the measurement value, based on the pieces of reference data, and writes the conversion table into the memory.

The object and advantages of the present invention will be realized and attained by means of the elements and combinations particularly pointed out in the claims.

It is to be understood that both the foregoing general description and the following detailed description are exemplary and explanatory and are not restrictive of the present invention.

### BRIEF DESCRIPTION OF DRAWINGS

FIG. 1 is a diagram illustrating a configuration example of a banknote handling device of the present disclosure;

FIG. 2 is a diagram illustrating an operation example 1 in the manufacturing phase of the banknote handling device of the present disclosure;

FIG. 3 is a diagram illustrating an operation example 2 in the manufacturing phase of the banknote handling device of the present disclosure;

FIG. 4 is a diagram illustrating an operation example 3 in the manufacturing phase of the banknote handling device of the present disclosure; and

FIG. 5 is a diagram illustrating an example of a processing procedure of the banknote handling device of the present disclosure.

### DESCRIPTION OF EMBODIMENTS

The sensitivity of a thickness sensor in the thickness sensor module varies from one thickness sensor to another. Hence, each of the thickness sensors may output a different detection value for the banknote having the same thickness.

Consequently, after the thickness sensor module is installed in a banknote handling device, by using a reference medium with a certain thickness, adjustment (hereinafter, may be referred to as a “sensor adjustment”) is performed on each banknote handling device so as to calculate a correction coefficient such that different detection values output from the thickness sensors for the reference medium become the same measurement value.

However, if the sensor adjustment using the reference medium such as above is performed on each banknote handling device, the number of steps in the manufacturing phase of the banknote handling device will be increased.

Therefore, in an aspect of the embodiments, the present disclosure proposes a technology capable of reducing the number of steps in the manufacturing phase of a banknote handling device.

Hereinafter, an embodiment of the present disclosure will be described with reference to the drawings.

### Embodiment

### Configuration of Banknote Handling Device

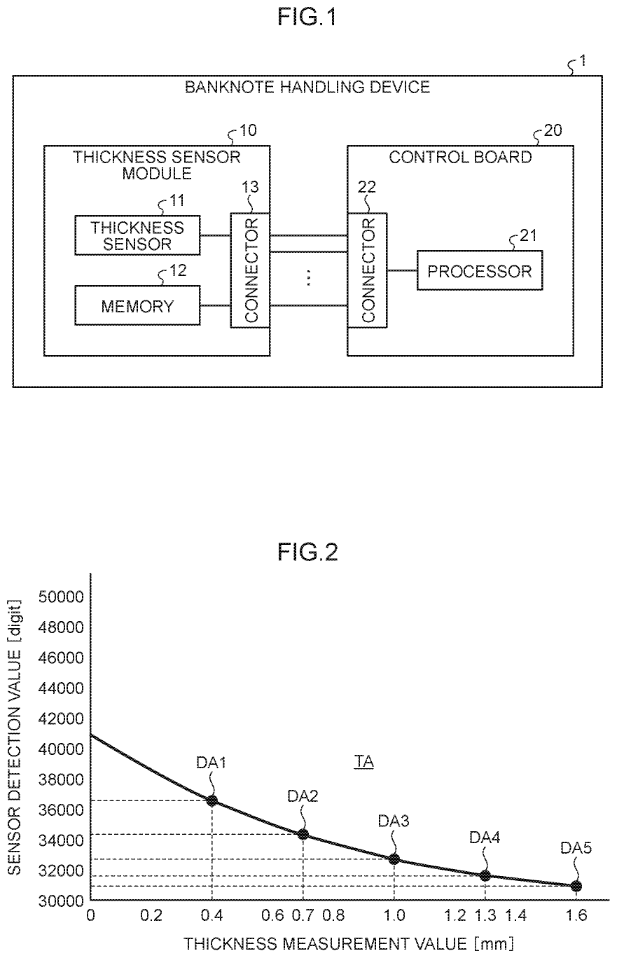

FIG. 1 is a diagram illustrating a configuration example of a banknote handling device of the present disclosure. In FIG. 1, a banknote handling device 1 includes a thickness sensor module 10 and a control board 20. The thickness sensor module 10 includes a thickness sensor 11, a memory 12, and a connector 13. The control board 20 includes a processor 21 and a connector 22. The thickness sensor module 10 and the control board 20 are connected via the connector 13 and the connector 22.

### Operation of Banknote Handling Device

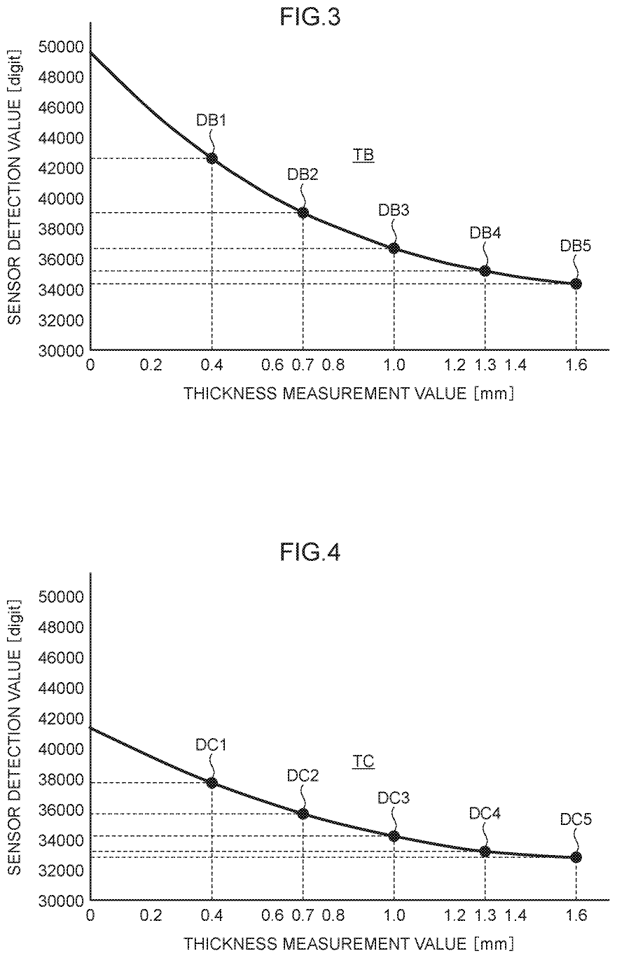

FIG. 2, FIG. 3, and FIG. 4 are diagrams each illustrating an operation example in the manufacturing phase of the banknote handling device of the present disclosure. FIG. 2 illustrates an operation example 1 when the thickness sensor 11 is a thickness sensor SA. FIG. 3 illustrates an operation example 2 when the thickness sensor 11 is a thickness sensor SB. FIG. 4 illustrates an operation example 3 when the thickness sensor 11 is a thickness sensor SC. The thickness sensors SA, SB, and SC are sensors of the same model. However, the sensitivity of each of the thickness sensors SA, SB, and SC varies from one thickness sensor to another. Hence, each of the thickness sensors SA, SB, and SC outputs a different detection value for the banknote having the same thickness. Therefore, in the present embodiment, as follows, a table (hereinafter, may be referred to as a “conversion table”) for converting the detection value (hereinafter, may be referred to as a “sensor detection value”) of the thickness sensor 11 into the measurement value (hereinafter, may be referred to as a “thickness measurement value”) of the thickness of the banknote is created for each of the thickness sensors SA, SB, and SC.

### Operation Example 1 (FIG. 2)

The operation example 1 illustrated in FIG. 2 is an operation example in the manufacturing phase of the banknote handling device 1, when the thickness sensor 11 is the thickness sensor SA.

As illustrated in FIG. 2, in the manufacturing phase of the banknote handling device 1, the processor 21 first reads reference data DA1, DA2, DA3, DA4, and DA5 indicating the association between the sensor detection values of the thickness sensor SA and the thickness measurement values from the memory 12. At the reference data DA1, the sensor detection value of 36546 is associated with the thickness measurement value of 0.4 mm. At the reference data DA2, the sensor detection value of 34283 is associated with the thickness measurement value of 0.7 mm. At the reference data DA3, the sensor detection value of 32692 is associated with the thickness measurement value of 1.0 mm. At the reference data DA4, the sensor detection value of 31626 is associated with the thickness measurement value of 1.3 mm. And at the reference data DA5, the sensor detection value of 30940 is associated with the thickness measurement value of 1.6 mm.

In this example, the reference data DA1, DA2, DA3, DA4, and DA5 are obtained in advance and written into the memory 12 prior to the shipment of the thickness sensor module 10, by the manufacturer of the thickness sensor module 10. In other words, the thickness sensor module 10 that includes the thickness sensor SA, is shipped from the manufacturer of the thickness sensor module 10 in the state where the reference data DA1, DA2, DA3, DA4, and DA5 are written into the memory 12, and is delivered to the manufacturer of the banknote handling device 1. At the manufacturer of the banknote handling device 1, after the thickness sensor module 10 in which the reference data DA1, DA2, DA3, DA4, and DA5 are written into the memory 12, is connected to the control board 20, the processor 21 reads the reference data DA1, DA2, DA3, DA4, and DA5 from the memory 12.

Next, on the basis of the reference data DA1, DA2, DA3, DA4, and DA5 read from the memory 12, the processor 21 creates a conversion table TA for converting the sensor detection value of the thickness sensor SA into the thickness measurement value, using an interpolation method. The conversion table TA illustrated in FIG. 2 is a conversion table for the thickness sensor SA, and for example, includes 1,600 data points obtained by the interpolation method in the thickness measurement value range from 0 mm to 1.6 mm. The 1,600 data points are merely an example, and the number of data points obtained by the interpolation method may be changed according to the detection range of thickness and the detection accuracy of the thickness.

Then, the processor 21 writes the created conversion table TA into the memory 12.

### Operation Example 2 (FIG. 3)

The operation example 2 illustrated in FIG. 3 is an operation example in the manufacturing phase of the banknote handling device 1, when the thickness sensor 11 is the thickness sensor SB.

As illustrated in FIG. 3, in the manufacturing phase of the banknote handling device 1, the processor 21 first reads reference data DB1, DB2, DB3, DB4, and DB5 indicating the association between the sensor detection values of the thickness sensor SB and the thickness measurement values from the memory 12. At the reference data DB1, the sensor detection value of 42572 is associated with the thickness measurement value of 0.4 mm. At the reference data DB2, the sensor detection value of 39042 is associated with the thickness measurement value of 0.7 mm. At the reference data DB3, the sensor detection value of 36682 is associated with the thickness measurement value of 1.0 mm. At the reference data DB4, the sensor detection value of 35222 is associated with the thickness measurement value of 1.3 mm. And at the reference data DB5, the sensor detection value of 34396 is associated with the thickness measurement value of 1.6 mm.

In this example, the reference data DB1, DB2, DB3, DB4, and DB5 are obtained in advance and written into the memory 12 prior to the shipment of the thickness sensor module 10, by the manufacturer of the thickness sensor module 10. In other words, the thickness sensor module 10 that includes the thickness sensor SB, is shipped from the manufacturer of the thickness sensor module 10 in the state where the reference data DB1, DB2, DB3, DB4, and DB5 are written into the memory 12, and is delivered to the manufacturer of the banknote handling device 1. At the manufacturer of the banknote handling device 1, after the thickness sensor module 10 in which the reference data DB1, DB2, DB3, DB4, and DB5 are written into the memory 12, is connected to the control board 20, the processor 21 reads the reference data DB1, DB2, DB3, DB4, and DB5 from the memory 12.

Next, on the basis of the reference data DB1, DB2, DB3, DB4, and DB5 read from the memory 12, the processor 21 creates a conversion table TB for converting the sensor detection value of the thickness sensor SB into the thickness measurement value, using the interpolation method. The conversion table TB illustrated in FIG. 3 is a conversion table for the thickness sensor SB, and for example, includes 1,600 data points obtained by the interpolation method in the thickness measurement value range from 0 mm to 1.6 mm.

Then, the processor 21 writes the created conversion table TB into the memory 12.

### Operation Example 3 (FIG. 4)

The operation example 3 illustrated in FIG. 4 is an operation example in the manufacturing phase of the banknote handling device 1, when the thickness sensor 11 is the thickness sensor SC.

As illustrated in FIG. 4, in the manufacturing phase of the banknote handling device 1, the processor 21 first reads reference data DC1, DC2, DC3, DC4, and DC5 indicating the association between the sensor detection values of the thickness sensor SC and the thickness measurement values from the memory 12. At the reference data DC1, the sensor detection value of 37856 is associated with the thickness measurement value of 0.4 mm. At the reference data DC2, the sensor detection value of 35787 is associated with the thickness measurement value of 0.7 mm. At the reference data DC3, the sensor detection value of 34272 is associated with the thickness measurement value of 1.0 mm. At the reference data DC4, the sensor detection value of 33310 is associated with the thickness measurement value of 1.3 mm. And at the reference data DC5, the sensor detection value of 32902 is associated with the thickness measurement value of 1.6 mm.

In this example, the reference data DC1, DC2, DC3, DC4, and DC5 are obtained in advance and written into the memory 12 prior to the shipment of the thickness sensor module 10, by the manufacturer of the thickness sensor module 10. In other words, the thickness sensor module 10 that includes the thickness sensor SC, is shipped from the manufacturer of the thickness sensor module 10 in the state where the reference data DC1, DC2, DC3, DC4, and DC5 are written into the memory 12, and is delivered to the manufacturer of the banknote handling device 1. At the manufacturer of the banknote handling device 1, after the thickness sensor module 10 in which the reference data DC1, DC2, DC3, DC4, and DC5 are written into the memory 12, is connected to the control board 20, the processor 21 reads the reference data DC1, DC2, DC3, DC4, and DC5 from the memory 12.

Next, on the basis of the reference data DC1, DC2, DC3, DC4, and DC5 read from the memory 12, the processor 21 creates a conversion table TC for converting the sensor detection value of the thickness sensor SC into the thickness measurement value, using the interpolation method. The conversion table TC illustrated in FIG. 4 is a conversion table for the thickness sensor SC, and for example, includes 1,600 data points obtained by the interpolation method in the thickness measurement value range from 0 mm to 1.6 mm.

Then, the processor 21 writes the created conversion table TC into the memory 12.

As in the operation examples 1, 2, and 3 described above, the processor 21 creates a conversion table for each of a plurality of the thickness sensors 11.

### Processing Procedure of Banknote Handling Device

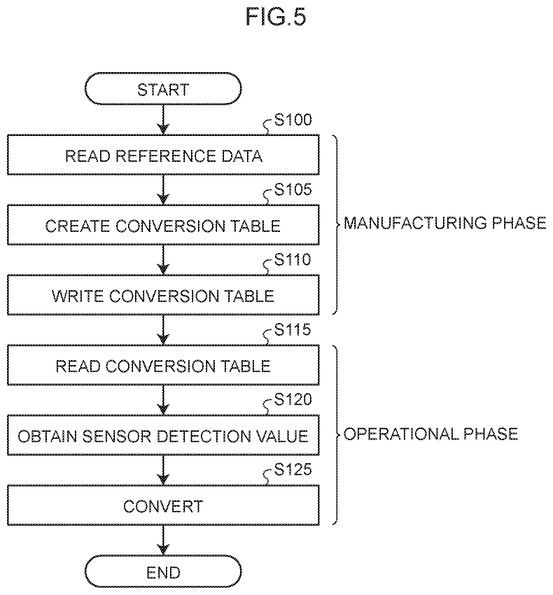

FIG. 5 is a diagram illustrating an example of a processing procedure of the banknote handling device of the present disclosure. In FIG. 5, the processes at steps S100, S105, and S110 are processes in the manufacturing phase of the manufacturer of the banknote handling device 1, and the processes at steps S115, S120, and S125 are processes in the user operational phase of the banknote handling device 1.

At step S100, the processor 21 reads a plurality of pieces of reference data indicating the association between the sensor detection values and the thickness measurement values from the memory 12.

Next, at step S105, the processor 21 creates a conversion table using the interpolation method, on the basis of the pieces of reference data read from the memory 12.

Next, at step S110, the processor 21 writes the created conversion table into the memory 12.

Next, at step S115, the processor 21 reads the conversion table from the memory 12 when measuring the thickness of the banknote using the thickness sensor 11.

Next, at step S120, the processor 21 obtains the sensor detection value output from the thickness sensor 11.

Then, at step S125, the processor 21 converts the sensor detection value (digit) into the thickness measurement value (mm) using the conversion table.

The embodiment has been described above.

As described above, the banknote handling device (banknote handling device 1 in the embodiment) of the present disclosure includes the thickness sensor module (thickness sensor module 10 in the embodiment) and the control board (control board 20 in the embodiment). The thickness sensor module includes the thickness sensor (thickness sensor 11 in the embodiment) for detecting the thickness of banknotes, and the memory (memory 12 in the embodiment). The control board includes the processor (processor 21 in the embodiment). In the memory, a plurality of pieces of reference data indicating the association between the detection values of the thickness sensor and the measurement values of the thickness of the banknote are stored. The processor reads the pieces of reference data stored in the memory from the memory, and creates a conversion table for converting the detection value into the measurement value on the basis of the pieces of read reference data, and writes the created conversion table into the memory.

In this manner, the sensor adjustment using a reference medium is no longer needed in the manufacturing phase of the banknote handling device. Hence, it is possible to reduce the number of steps in the manufacturing phase of the banknote handling device. Moreover, the thickness sensor module includes the memory that stores the pieces of reference data indicating the association between the detection values of the thickness sensor and the measurement values of the thickness of the banknote, whereby replacement of the thickness sensor module alone is facilitated. Hence, the maintainability of the banknote handling device will be improved.

Furthermore, the processor creates a conversion table using the interpolation method on the basis of the pieces of reference data.

In this manner, it is possible to create a conversion table covering a wide range of thickness measurement values from a small number of reference data.

Still furthermore, after writing the conversion table into the memory, the processor reads the conversion table from the memory when measuring the thickness of the banknote using the thickness sensor, and converts the sensor detection value into the thickness measurement value using the conversion table.

In this manner, even if the sensitivity of each thickness sensor varies, because the sensor detection values can be converted into the same thickness measurement value, it is possible to obtain the correct thickness measurement value.

According to the disclosed technology, in an aspect of the embodiments, it is possible to reduce the number of steps in the manufacturing phase of a banknote handling device.

All examples and conditional language provided herein are intended for the pedagogical purposes of aiding the reader in understanding the present invention and the concepts contributed by the inventor to further the art, and are not to be construed as limitations to such specifically recited examples and conditions, nor does the organization of such examples in the specification relate to a showing of the superiority and inferiority of the present invention. Although one or more embodiments of the present invention have been described in detail, it should be understood that the various changes, substitutions, and alterations could be made hereto without departing from the spirit and scope of the present invention.

What is claimed is

1. A banknote handling device comprising:
a thickness sensor module that includes a thickness sensor configured to detect a thickness of a banknote, and a memory; and
a control board that includes a processor, wherein
the processor
reads a plurality of pieces of reference data from the memory, the pieces of reference data indicating association between a detection value of the thickness sensor and a measurement value of the thickness of the banknote, and being stored in the memory,
creates a conversion table for converting the detection value into the measurement value, based on the pieces of reference data, and
writes the conversion table into the memory.

2. The banknote handling device according to claim 1, wherein the processor creates the conversion table using an interpolation method based on the pieces of reference data.

3. The banknote handling device according to claim 1, wherein after writing the conversion table into the memory, the processor reads the conversion table from the memory when measuring the thickness of the banknote using the thickness sensor, and converts the detection value into the measurement value using the conversion table.

4. The banknote handling device according to claim 1, wherein the processor creates a different conversion table for each thickness sensor.

5. A conversion table creation method comprising:
by a processor,
reading a plurality of pieces of reference data from a memory, the pieces of reference data indicating association between a detection value of a thickness sensor configured to detect a thickness of a banknote and a measurement value of the thickness of the banknote and being stored in the memory; and
creating a conversion table for converting the detection value into the measurement value, based on the pieces of reference data.
